(19) United States
(12) Patent Application Publication
(10) Pub. No.: US 2017/0011437 A1
(43) Pub. Date: Jan. 12, 2017

(54) SYSTEMS, METHODS, AND COMPUTER PROGRAM PRODUCTS FOR DETECTING BILLING ANOMALIES

(71) Applicant: United Parcel Service of America, Inc., Atlanta, GA (US)

(72) Inventors: Sathiyan Parameswaran, Morris Plaines, NJ (US); Dipanjan Paul, Metuchen, NJ (US); Don Sheridan, Emerson, NJ (US); Karl Wixtrom, Warwick, NY (US); John F. Przezdzecki, Caldwell, NJ (US); Timothy J. Eisentraut, Middletown, NY (US); Niraj R. Patel, Fair Lawn, NJ (US)

(21) Appl. No.: 14/794,074

(22) Filed: Jul. 8, 2015

(51) Int. Cl. G06Q 30/04

(52) U.S. Cl. CPC G06Q 30/04

(57) ABSTRACT

Systems, methods, and computer program products for validating billing data and detecting anomalies in billing data are provided. In one embodiment a method is provided, the method comprising: receiving historical billing data for a customer, the historical billing data organized into a plurality of historical data sets; calculating a plurality of statistical representations of each of the plurality of historical data sets; generating a historical profile for the customer based on the plurality of statistical representations of the historical billing data; receiving current billing data for the customer; generating a current profile for the customer; comparing the current profile to the historical profile, the current profile and the historical profile being associated with the same at least one category attribute; and, based at least in part on the result of the comparison, determining whether one or more anomalies are present in the current billing data for the customer.

### BACKGROUND

Automated and computer-assisted billing are important tools for service and/or product providers. Indeed, billing and invoicing operations have a direct and critical impact on a service and/or product provider's cash flow. However, for many mid to large size service and/or product providers, the billing and invoicing application processes tend to be inherently complex in nature. For example, incentives may be applied to various customer accounts in a non-linear fashion and may vary from one billing cycle to the next, leading to a non-linear system having a high degree of embedded process exceptions. For example, billing rules may depend on individualized client contracts, fee schedules, and discounts. Moreover, for a mid to large size service and/or product provider, the volume of charges may make manual billing or manual checking of bills prohibitive. For example, a service and/or product provider may bill hundreds to hundreds of millions or more charges per week. Therefore, it is important that automated and computer-assisted billing applications have high quality assurance processes.

The conventional methods of assuring quality typically depend on developing a series of operational checks and balances embedded throughout the system. Such methods are also augmented by performing random manual checks. Some organizations have developed parallel systems to validate process quality and provide the necessary assurances. However, such quality assurance methods are normally extremely cost prohibitive, incur a large amount of organization resources, and often are not very effective in detecting quality issues. Additionally, these methods fail to catch the new or unknown unknowns and are not very adaptable to dynamic changes in business operations.

Thus, there is a need for improving quality assurance for automated and/or computer-assisted billing applications. In particular, there is a need for systems, methods, computer program products, and apparatuses for validating billing information/data and/or invoices and detecting and/or identifying billing anomalies.

### BRIEF SUMMARY

Embodiments of the present invention provide systems, methods, computer program products, and apparatuses for detecting billing anomalies. Various embodiments of the present invention are configured to identify billing anomalies on the micro-level before providing invoices to clients.

In one aspect of the present invention, a method for identifying an anomaly in billing data is provided. In one embodiment, the method comprises receiving historical billing data for a customer. The historical billing data corresponds to one or more billing cycles preceding a current billing cycle, wherein the current billing cycle is a billing cycle for which the customer has not yet been billed. The historical billing data is organized into a plurality of historical data sets with each historical data set comprising a plurality of historical transactions. Each historical transaction is associated with one or more category attributes and each of the one or more category attributes is associated with a unique category. The method further comprises calculating a plurality of statistical representations of each of the plurality of historical data sets, wherein each of the plurality statistical representations is associated with at least one category attribute; generating a historical profile for the customer, the historical profile associated with at least one category attribute and based at least in part on the statistical representations corresponding to the at least one category attribute, the historical profile being a statistical model of the historical billing data; and receiving current billing data for the customer. The current billing data corresponds to the current billing cycle for the customer. The current billing data comprises a plurality of current transactions. Each current transaction is associated with one or more current category attributes and each of the one or more current category attributes is associated with a unique category. The method further comprises generating a current profile for the customer, the current profile associated with at least one category attribute, the current profile being a statistical model of the current billing data; comparing the current profile to the historical profile, the current profile and the historical profile being associated with the same at least one category attribute; and, based at least in part on the result of the comparison, determining whether one or more anomalies are present in the current billing data for the customer.

In another aspect of the present invention, a system for identifying anomalies in billing data is provided. In one embodiment the system comprises at least one processor and at least one memory. The at least one memory, with the processor, causes the system to at least receive historical billing data for a customer. The historical billing data corresponds to one or more billing cycles preceding a current billing cycle. The current billing cycle is a billing cycle for which the customer has not yet been billed. The historical billing data is organized into a plurality of historical data sets with each historical data set comprising a plurality of historical transactions. Each historical transaction is associated with one or more category attributes and each of the one or more category attributes associated with a unique category. The at least one memory, with the processor, further causes the system to calculate a plurality of statistical representations of each of the plurality of historical data sets, wherein each of the plurality statistical representations is associated with at least one category attribute; generate a historical profile for the customer, the historical profile associated with at least one category attribute and based at least in part on the statistical representations corresponding to the at least one category attribute, the historical profile being a statistical model of the historical billing data; and receive current billing data for the customer. The current billing data corresponding to the current billing cycle for the customer. The current billing data comprises a plurality of current transactions. Each current transaction is associated with one or more current category attributes and each of the one or more current category attributes associated with a unique category. The at least one memory, with the processor, further causes the system to generate a current profile for the customer, the current profile associated with at least one category attribute, the current profile being a statistical model of the current billing data; compare the current profile to the historical profile, the current profile and the historical profile being associated with the same at least one category attribute; and based at least in part on the result of the comparison, determine whether one or more anomalies are present in the current billing data for the customer.

According to still another aspect of the present invention, a non-transitory computer program product is provided. In one embodiment, the computer program product comprises at least one computer-readable storage medium having computer-readable program code portions embodied therein. The computer-readable portions comprise an executable portion configured to receive historical billing data for a customer. The historical billing data corresponds to one or more billing cycles preceding a current billing cycle. The current billing cycle is a billing cycle for which the customer has not yet been billed. The historical billing data is organized into a plurality of historical data sets with each historical data set comprising a plurality of historical transactions. Each historical transaction is associated with one or more category attributes and each of the one or more category attributes associated with a unique category. The computer-readable portions further comprise an executable portion configured to calculate a plurality of statistical representations of each of the plurality of historical data sets, wherein each of the plurality statistical representations is associated with at least one category attribute; an executable portion configured to generate a historical profile for the customer, the historical profile associated with at least one category attribute and based at least in part on the statistical representations corresponding to the at least one category attribute, the historical profile being a statistical model of the historical billing data; and an executable portion configured to receive current billing data for the customer. The current billing data corresponds to the current billing cycle for the customer. The current billing data comprises a plurality of current transactions. Each current transaction is associated with one or more current category attributes and each of the one or more current category attributes associated with a unique category. The computer-readable portions further comprise an executable portion configured to generate a current profile for the customer, the current profile associated with at least one category attribute, the current profile being a statistical model of the current billing data; an executable portion configured to compare the current profile to the historical profile, the current profile and the historical profile being associated with the same at least one category attribute; and an executable portion configured to, based at least in part on the result of the comparison, determine whether one or more anomalies are present in the current billing data for the customer.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 is a block diagram of a system architecture that may be used in conjunction with various embodiments of the present invention;

FIG. 2 is schematic block diagram of a billing system according to various embodiments of the present invention;

FIG. 3 is a flow chart illustrating an overview of a method for detecting billing anomalies according to various embodiments of the present invention;

FIGS. 4 and 9 illustrate example views of an anomaly detecting interface, in accordance with an embodiment of the present invention;

FIGS. 5, 7, and 8 provide a flow chart illustrating various processes and procedures that may be completed in accordance with an embodiment of the present invention; and

FIGS. 6A, 6B, 6C, and 6D provide an example of a sample organized by category attribute for each historical data set, an example statistical representation for each historical data set, an example historical profile for a category, and an example current profile for a category, respectfully, in accordance with various embodiments of the present invention.

### DETAILED DESCRIPTION

Various embodiments of the present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory (VRAM), cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. GENERAL OVERVIEW

Embodiments of the present invention are directed to validating billing data/information (e.g., application of incentives to a customer's bill) and/or detecting anomalies in billing data/information. In various embodiments, billing information/data may comprise one or more transactions, incentive data, and/or the like. For example, the billing information/data may transactional billing data, aggregate invoice level data, and customer contract bid level data. For example, each transaction of the transactional billing data may be associated with one or more category attributes and/or one or more variable values, as will be discussed in more detail later herein. In various embodiments, historical billing information/data may be analyzed to build a historical profile for a customer. The current billing information/data (e.g., billing information/data for the current billing cycle or the billing cycle that is currently being processed for billing) may also be analyzed to build a current profile for the customer. The historical profile and the current profile may be compared to validate the current profile and/or identify any anomalies present in the current billing information/data. For example, one or more statistical representations of the historical billing information/data calculated and/or determined to characterize the historical profile. The current profile may be characterized based on one or more statistical representations of the current billing information/data. The current profile may then be compared against the historical profile to verify the current profile and/or identify any anomalies present in the current billing information/data. For example, the current profile may be compared to the historical profile using one or more statistical tests/measures. In various embodiments, only billing data associated with the customer is used in the generation of the historical profile and the current profile (e.g., a current profile for Company A is compared against a historical profile for Company A).

Various embodiments of the present invention validate the application of incentives to a bill for the customer of a carrier and/or to identify anomalies in the application of incentives to a customer's bill as an example application of one embodiment of the present invention. A carrier may be any entity that can carry out or facilitate the transportation and/or delivery of packages, items, shipments, freight, and/or the like (e.g., UPS, USPS, and/or the like). For instance, a carrier may be a traditional carrier, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. However, a carrier may also be a nontraditional carrier, such as Amazon, Google, Uber, ride-sharing services, crowd-sourcing services, retailers, and/or the like. However, embodiments of the present invention are not limited to carriers. Thus, it should be understood that a variety of service and/or product providers, in addition to carriers, may use aspects of various embodiments of the present invention to validate and/or identify anomalies in billing information/data.

### III. SYSTEM ARCHITECTURE

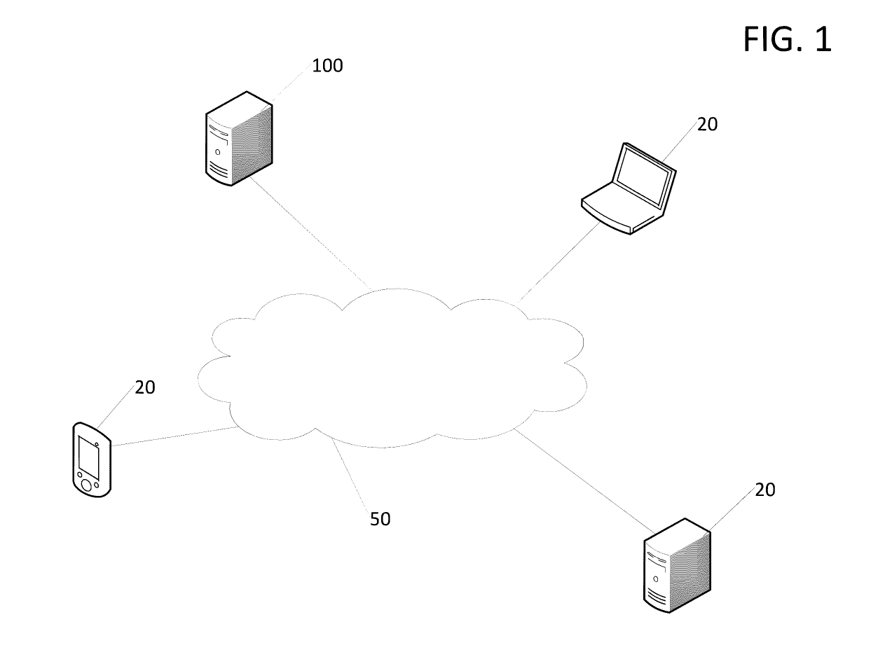

FIG. 1 illustrates an example embodiment of a system architecture that may be used in conjunction with various embodiments of the present invention. The embodiment illustrated in FIG. 1 includes one or more billing systems 100, one or more customer computing entities 20, and one or more networks 50. Each of these components may be in direct or indirect communication with, for example, one another over the same or different wired or wireless networks 50. Additionally, although the system entities can be separate, standalone entities, the various embodiments are not limited to this particular architecture.

### 1. Billing System

The billing system 100 may be operated by and/or on behalf of a service and/or product provider (e.g., an individual, group, organization, corporation, company, business, department, carrier, and/or the like) that may process billing information/data, invoice one or more customers, and/or the like. In various embodiments, the billing system 100 may be configured to bill one or more customers for services and/or products provided by the service and/or product provider associated with the billing system 100. In one embodiment, the billing system 100 is operated by a carrier and is configured to bill one or more customers for the transportation, pick up, delivery, and/or the like of one or more items or shipments and/or other services related to the transportation, pick up, delivery and/or the like of one or more items or shipments. An item may be any tangible and/or physical object. In one embodiment, an item may be or be enclosed in one or more packages, parcels, bags, containers, loads, crates, items banded together, vehicle parts, pallets, drums, the like, and/or similar words used herein interchangeably. Such items may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. In this regard, in some example embodiments, an item may communicate send “to” address information/data, received “from” address information/data, unique identifier codes, and/or various other information/data. In one embodiment, each item may include an item/shipment identifier, such as an alphanumeric identifier. Such item/shipment identifiers may be represented as text, barcodes, tags, character strings, Aztec Codes, MaxiCodes, Data Matrices, Quick Response (QR) Codes, electronic representations, and/or the like. A unique item/shipment identifier (e.g., 123456789) may be used by the carrier to identify and track the item as it moves through the carrier's transportation network. Further, such item/shipment identifiers can be affixed to items by, for example, using a sticker (e.g., label) with the unique item/shipment identifier printed thereon (in human and/or machine readable form) or an RFID tag with the unique item/shipment identifier stored therein.

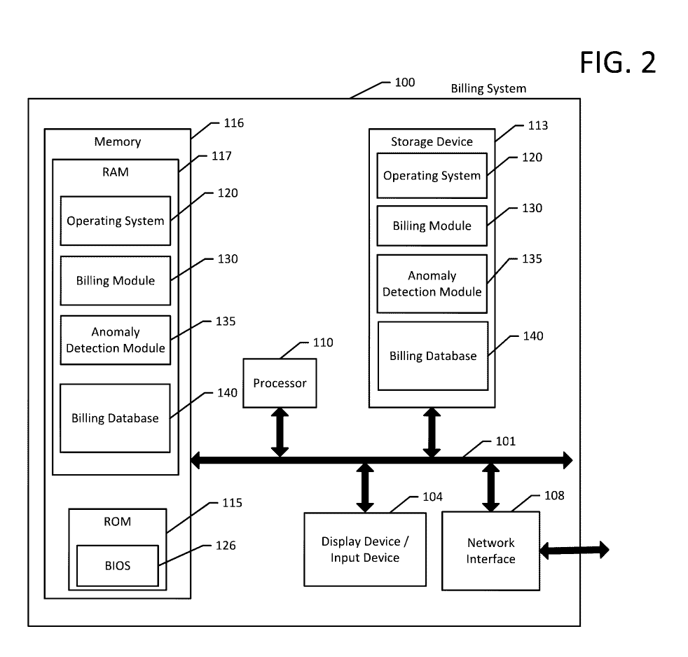

FIG. 2 shows a schematic diagram of an example billing system 100. In general, the term system may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, televisions, dongles, cameras, wristbands, wearable items/devices, items/devices, vehicles, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the billing system 100 may also include one or more communications interfaces for communicating with various computing entities, such as by communicating data, content, information, and/or similar terms used herein interchangeably that can be transmitted, received, operated on, processed, displayed, stored, and/or the like. For instance, the billing system 100 may communicate with customer computing entity 20.

In one embodiment, the billing system 100 may include or be in communication with one or more processing elements 110 (also referred to as processors, processing circuitry, and/or similar terms used herein interchangeably) that communicate with other elements within the billing system 100 via a bus 101, for example. As will be understood, the processing element 110 may be embodied in a number of different ways. For example, the processing element may be embodied as one or more complex programmable logic devices (CPLDs), microprocessors, multi-core processors, coprocessing entities, application-specific instruction-set processors (ASIPs), and/or controllers. Further, the processing element 110 may be embodied as one or more other processing devices or circuitry. The term circuitry may refer to an entirely hardware embodiment or a combination of hardware and computer program products. Thus, the processing element 110 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 110 may be configured for a particular use or configured to execute instructions stored in volatile or non-volatile media or otherwise accessible to the processing element. As such, whether configured by hardware or computer program products, or by a combination thereof, the processing element 110 may be capable of performing steps or operations according to embodiments of the present invention when configured accordingly.

In one embodiment, the billing system 100 may further include memory or be in communication with memory 116, which may comprise non-volatile media (also referred to as non-volatile storage, memory, memory storage, memory circuitry and/or similar terms used herein interchangeably). In one embodiment, the non-volatile storage or memory 116 may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. For example, the non-volatile storage or memory may store code such as the billing module 130 and/or anomaly detection module 135. The non-volatile storage or memory may store the billing database 140. The term database, database instance, database management system, and/or similar terms used herein interchangeably may refer to a structured collection of records or data that is stored in a computer-readable storage medium, such as via a relational database, hierarchical database, and/or network database.

In one embodiment, the memory 116 may further comprise volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element. Thus, the databases, database instances, database management systems, data, applications, programs, program modules, scripts, source code, object code, byte code, compiled code, interpreted code, machine code, executable instructions, and/or the like may be used to control certain aspects of the operation of the billing system 100 with the assistance of the processing element 110 and operating system 120.

In various embodiments, memory 116 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 110 using an I/O bus instead of a dedicated bus. The memory 116 could also be secondary memory, such as disk storage, that stores a relatively large amount of data. The secondary memory may be a floppy disk, hard disk, compact disk, DVD, or any other type of mass storage type known to those skilled in the computer arts. The memory 116 may also comprise any application program interface, system, libraries and any other data by the processor to carry out its functions. ROM 115 is used to store a basic input/output system 126 (BIOS), containing the basic routines that help to transfer information between components of the billing system 100, including the billing module 130, the anomaly detection module 135, the billing database 140, and/or the operating system 120.

In addition, the billing system 100 includes at least one storage device 113, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 113 is connected to the system bus 101 by an appropriate interface. It is important to note that the computer-readable media described above could be replaced by any other type of computer-readable media known in the art. Such media include, for example, memory sticks (e.g., USB memories), magnetic cassettes, flash memory cards, digital video disks, and Bernoulli cartridges.

A number of program modules may be stored by the various storage devices and within RAM 117. Such program modules include the operating system 120, the billing module 130, and/or the anomaly detection module 135. Those skilled in the art will appreciate that other modules may be present in RAM 117 to effectuate the various embodiments of the present invention. Furthermore, rather than program modules, the billing module 130, and/or the anomaly detection module 135 may comprise stand-alone computers connectively coupled to the billing system 100.

Also located within the billing system 100 is a network interface 108, for interfacing and communicating with other elements of a computer network, such as by communicating data, content, information, and/or similar terms used herein interchangeably that can be transmitted, received, operated on, processed, displayed, stored, and/or the like. For instance, the billing system 100 may be in communication with one or more customer computing entities 20. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the route planning server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various data, information, and other similar words used herein interchangeably is input by a user to the billing system 100 via the network interface 108 and/or input/output device 104. This input information may include information related to packages to be delivered, information related to the delayed deposit of COD payment mechanisms, or other information. This input information may vary, however, depending on the configuration and informational requirements of the billing system 100.

As mentioned above, the billing system 100 also includes an input/output device 104 for receiving and displaying information/data. The billing system 100 may include or be in communication with one or more input elements, such as a keyboard input, a mouse input, a touch screen/display input, audio input, pointing device input, joystick input, keypad input, and/or the like, as indicated by input/output device 104. The billing system 100 may also include or be in communication with one or more output elements, as indicated by input/output device 104, such as audio output, video output, screen/display output, motion output, movement output, and/or the like.

The billing system 100 is configured to facilitate billing one or more clients, customers, and/or similar words used herein interchangeably for one or more provided services and/or products. The billing system 100 may be further configured to identify one or more anomalies in current billing information/data before a customer is billed and/or invoiced for the services and/or products associated with the current billing information/data. The billing system 100 may be configured to be in communication with one or more customer computing entities 20 and/or one or more other computing entities associated with the service and/or product provider, individual, group, organization, corporation, company, business, department, and/or the like.

The billing system 100 may also comprise various other systems, such as an Flexible Core Billing (FCB), Consolidated Data Capture (CDC), Miscellaneous Data Capture (MDC), Enterprise Billing Adjustments (EBA), Billing Revenue Recovery Systems (BRRS), Flexible Bill Rendering (FBR), Incentive Administrative System (IAS), Import Billing System (IBS), Import Billing Feed (IBF), Bundled Invoicing System (BIS), Customer Resource Information System (CRIS), International Customer Resource Information System (ICRIS), Electronic Data Interchange (EDI), and a variety of other systems and their corresponding components.

Those skilled in the art will recognize that many other alternatives and architectures are possible and can be used to practice various embodiments of the invention. The embodiment illustrated in FIG. 2 can be modified in different ways or incorporated within a network and be within the scope of the invention. For example, one or more components of the billing system 100 may be located remotely from other billing system 100 components, such as in a distributed system. Furthermore, one or more of the components may be combined and additional components performing functions described herein may be included in the billing system 100. Thus, the billing system 100 can be adapted to accommodate a variety of needs and circumstances.

### 2. Customer Computing Entity

A customer (e.g., consignor, consignee, shipper, or receiver) may be an individual, a family, a company, an organization, an entity, a department within an organization, a representative of an organization and/or person, and/or the like. For example, a customer may receive one or more services and/or products from the service and/or product provider. A customer computing entity 20 may be operated by and/or on behalf of a customer of the service and/or product provider. The customer computing entity 20 may include one or more components that are functionally similar to those of the billing system 100. For example, in one embodiment, each customer computing entity 20 may include one or more processing elements, one or more display device/input devices, volatile and non-volatile storage or memory, and/or one or more communications interfaces. These architectures are provided for exemplary purposes only and are not limiting to the various embodiments. Further, the term computing device may refer to one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, televisions, dongles, cameras, wristbands, wearable items/devices, items/devices, vehicles, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

### IV. SYSTEM OPERATION

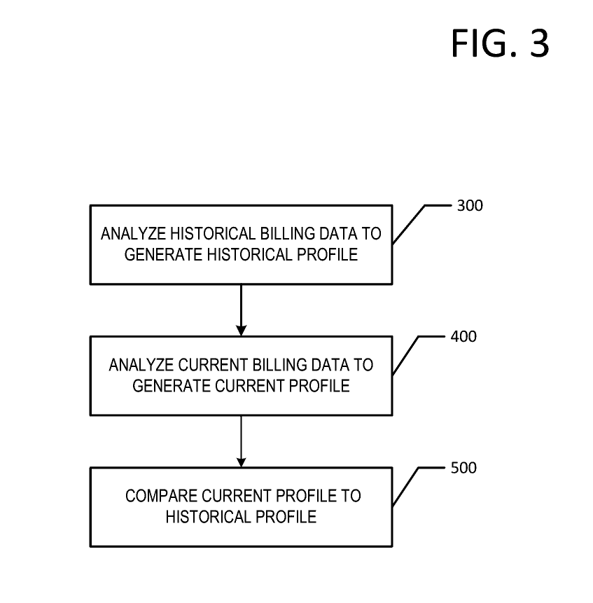

FIG. 3 provides a flowchart illustrating an overview of validating and/or identifying anomalies in the application of incentives to the customer's bill and/or the like. For example, according to various embodiments, the process of validating the application of incentives to a customer's bill and/or identification of anomalies therein begins at step 300, by analyzing historical billing information/data to calculate/generate/determine a historical profile for the customer. For example, the billing system 100 may analyze historical billing information/data to calculate/generate/determine a historical profile for the customer based on one or more categories and/or variables associated with the historical billing information/data. For example, the processor 110 may access historical billing information/data stored in, for example, the billing database 140 and analyze the historical billing information/data to calculate/generate/determine a historical profile for the customer. In various embodiments, the historical profile comprises one or more statistical representations of the historical billing information/data. For example, the historical profile may comprise one or more statistical representations (e.g., an average or a mean-of-means and a standard deviation) of the incentive factor per item based on a category, variable, and/or micro-segment associated with the item, as will be described in more detail below. For example, the historical profile may comprise the average incentive factor and standard deviation thereof for each item shipped by a customer during the time period associated with the historical billing information/data by Service Type (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like) with each Service Type broken down by billed item weight class (e.g., items with billed weight of 0-0.5 pounds, 0.5-1 pounds, 1-3 pounds, 3-5 pounds, 5-10 pounds, 10-20 pounds, 20-30 pounds, and/or the like). The historical profile may comprise statistical representations of the historical billing information/data for any number of categories, variable, or combinations of categories and/or variables (e.g., micro-segments), as appropriate for the application.

At step 400, the current billing information/data is analyzed and a current profile is calculated/generated/determined. For example, the billing system 100 may analyze the current billing information/data and calculate/generate/determine a current profile for the customer based on one or more categories and/or variables associated with the current billing information/data. For example, the processor 110 may access current billing information/data stored in, for example, the billing database 140 and calculate/generate/determine a current profile for the customer. In various embodiments, the current profile comprises one or more statistical representations of the current billing information/data. For instance, the current profile may comprise one or more statistical representations (e.g., an average and a standard deviation) of the incentive factor per item based on a category and/or micro-segment associated with the item, as will be described in more detail below. For example, the current profile may comprise the average incentive factor for each item shipped by a customer during the time period associated with the current billing information/data by Service Type (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like) with each Service Type broken down by billed item weight class (e.g., items with billed weight of 0-0.5 pounds, 0.5-1 pounds, 1-3 pounds, 3-5 pounds, 5-10 pounds, 10-20 pounds, 20-30 pounds, and/or the like). Generally, though not necessary, the categories, variables, and micro-segments of the current profile each correspond to a category, variable, or micro-segment of the historical profile.

At step 500, the current profile is compared to the historical profile to validate the current profile and/or to determine if any anomalies are present in the current billing information/data. For example, the billing system 100 may validate the current profile and/or determine if any billing anomalies are present in the current billing information/data based on a statistical comparison of the current profile to the historical profile. For example, for each weight class for each Service Type, the average incentive factor of the current profile may be compared to the average incentive factor for the corresponding billed item weight class and Service Type of the historical profile. The comparison may be based on the corresponding standard deviation of the historical profile. Various steps and processes of validating a current profile and/or detecting an anomaly in the current profile for a customer will now be described in more detail.

### 1. Analysis Request

In various embodiments, a user may submit an analysis request and/or an analysis request may be automatically submitted to initiate and/or schedule the analysis of the current billing information/data for a customer to validate the application of incentives and/or identify any anomalies present in the application of incentives to a customer's account. For example, the billing system 100 (or other appropriate computing device) may automatically submit an analysis request based on predetermined and/or default parameters. In various embodiments, predetermined parameters to be used for analysis of the billing information/data for a customer may be stored in association with a customer profile for the customer. In various embodiments, an analysis request for a particular customer, for each of a particular subset of customers, or for each customer may be provided. Each analysis request may be configured to cause the initiation of an analysis and/or scheduling of one or more analyses. For example, analysis requests scheduling analysis of the current billing information/data for a particular customer, for each customer of a particular subset of customers, or for each customer may be automatically provided (e.g., by the billing system 100) on a regular or periodic basis as indicated by the predetermined parameters indicated by the analysis request and/or in response to certain triggers.

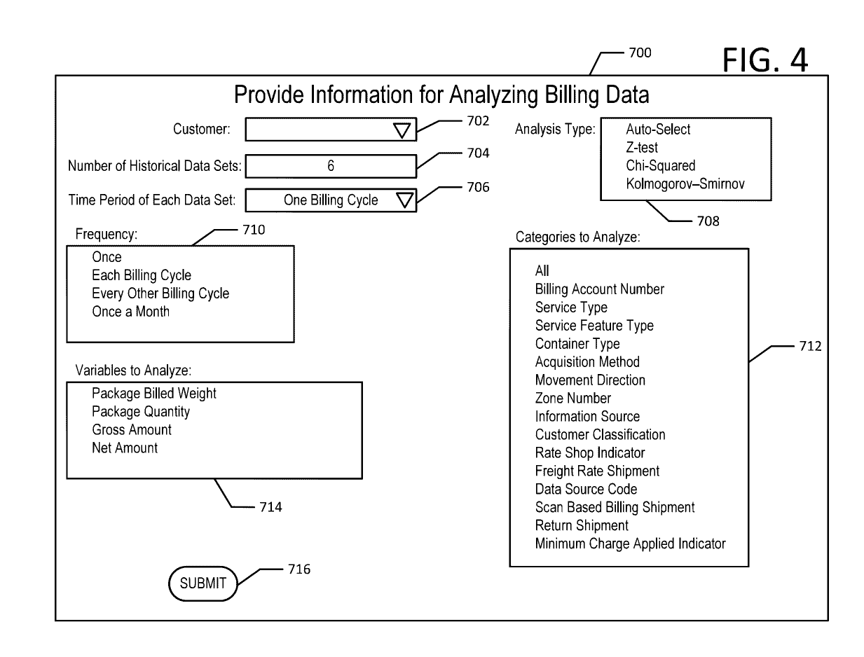

In various embodiments, a user (e.g., an employee of the carrier) may provide information via an analysis interface to submit an analysis request to initiate, schedule, and/or the like one or more analyses of the current billing information/data for each of one or more customers based on predetermined and/or default parameters and/or user provided parameters. In response to receiving an analysis request, the billing system 100 may initiate, schedule, and/or the like an analysis or analyses of the current billing information/data identified in the analysis request to identify any anomalies that may be present in the current billing information/data. FIG. 4 provides an example of an analysis interface 700 that may be used to submit an analysis request. For example, the analysis interface 700 may include a customer identifier 702, parameter input fields (e.g., 704, 706), analysis type selector 708, frequency selector 710, category selector 712, variable selector 714, and submit button 716.

In various embodiments, the customer identifier 702 may be configured to be populated with input indicating a customer name, customer identification number, a billing account number associated with the customer, and/or the like. For example, a user (e.g., via display/input device 104 or a computing device in communication with the billing system 100) may provide a customer name or a customer identification number. In some embodiments, the customer identifier 702 may be configured to allow a user (e.g., via display/input device 104 or a computing device in communication with the billing system 100) to select a customer name and/or identification number from a list of customer names and/or identification numbers. In various embodiments, a customer may be associated with one or more billing accounts. In some embodiments, an analysis may be requested for each billing account or for a combined analysis of all or a subset of the billing accounts associated with the customer.

In various embodiments, various parameter input fields (e.g., 704, 706) may be provided. For example, a user (e.g., via display/input device 104 or a computing device in communication with the billing system 100) may provide input indicating and/or select the number of historical data sets to be used to calculate/generate/determine the historical profile by inputting a number or selecting a number from a provided list at input field 704. For example, a historical data set is associated with a time period (e.g., a billing cycle, a day, a week, two weeks, a month, two months, a quarter, a year, and/or the like) and comprises historical billing information/data (e.g., billing information/data associated with items shipped by/to the customer during the corresponding time period). In some embodiments, a minimum of two historical data sets are used. In various embodiments, the default number of historical data sets used to calculate/generate/determine the historical profile is six. In another example, a user (e.g., via display/input device 104 or a computing device in communication with the billing system 100) may provide input indicating and/or select the time period (e.g., one day, one week, two weeks, half a month, one month, one quarter, one billing cycle, and/or the like) corresponding to each historical data set to be used to calculate/generate/determine the historical profile by inputting a time period or selecting a time period from a provided list at field 706. For example, the user (e.g., via display/input device 104 or a computing device in communication with the billing system 100) may indicate that each data set should correspond to one billing cycle and six data sets (e.g., six weeks of historical billing information/data) and should be analyzed to calculate/generate/determine the historical profile. In some embodiments, the time period for each historical data set is determined by the length of a billing cycle for the customer. In various embodiments, the default time period corresponding to each historical data set is one billing cycle and/or one week. Various other parameter input fields may be provided as appropriate for the application.

In various embodiments, the user (e.g., via display/input device 104 or a computing device in communication with the billing system 100) may select an analysis type via the analysis type selector 708. For example, the user may select a particular statistical model or test to use in the comparison of the current profile to the historical profile. For example, the user may select a chi-squared model, z-test model, Kolmogorov-Smirnov (KS) model, and/or other statistical models to compare the current profile to the historical profile. In some embodiments, various categories and/or variables may be associated with a preferred statistical analysis. For example, fluctuations in the volume variable may be associated with a chi-squared model. Thus, the user may select to have the analysis type be automatically selected for each point of comparison of the current profile to the historical profile. For example, the points of comparison may be each category, variable, and/or micro-segment for which the historical profile and the current profile both comprise a statistical representation of the billing information/data, or a subset thereof. For example, the points of comparison in one embodiment may be the average incentive factor by Service Type and billed item weight and the average billed amount by the geographical zone to which the item is delivered. Other embodiments may include fewer or more points of comparison. In some embodiments, the billing system 100 may compare each point of comparison of current profile to the historical profile using the preferred statistical model associated with the category, variable, and/or micro-segment associated with that point of comparison.

In various embodiments, the user (e.g., via display/input device 104 or a computing device in communication with the billing system 100) may select a frequency with which to validate the application of incentives to a customer account and/or identify anomalies via the frequency selector 710. For example, the analysis may be completed more than once for each billing cycle (e.g., a weekly analysis may be completed for a monthly billing cycle), once each billing cycle (e.g., the analysis may be completed for each billing cycle), less than once for each billing cycle (e.g., once a month for a weekly billing cycle), in response to certain triggers, and/or the like. In some embodiments, the user may initiate a single (e.g., one time) analysis of the current billing information/data.

In various embodiments, the user (e.g., via display/input device 104 or a computing device in communication with the billing system 100) may select one or more categories to analyze to validate the application of incentives to a customer account and/or identify anomalies therein via the category selector 712. In various embodiments, each category represents an element that at least in part describes a service and/or product provided. In the example in which the billing system 100 is operated by and/or on behalf of a carrier, each category may be an element of the package level information/data (PLD) for items, packages, shipments, and/or the like picked-up, delivered, and/or transported by the carrier. For example, in one embodiment, the categories may comprise Billing Account Number, Service Type (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like), Service Feature Type (e.g., Single Piece Business, Multiple Piece Business Hundredweight, and/or the like), Container Type (e.g., letter/envelope, package, box, pallet, cargo container, and/or the like), Acquisition Method (e.g., how the carrier acquired the package: picked-up, brought to carrier store-front, placed in carrier drop-box, and/or the like), Movement Direction (e.g., national, export, import), Zone Number (e.g., indicating a general geographical region to which the item is being delivered or a category of distance the item is moved through the carrier's transportation network), Information Source (e.g., a particular shipping program used to provide shipping information to the carrier such as World Ship, Campus Ship, iShip, and/or the like), Customer Classification (e.g., one time customer, regular shippers, credit card account, and/or the like), Rate Shop Indicator (e.g., multi-piece vs. single-piece incentives; indicates whether the customer wants the carrier to compare the final charges based on single piece and multi-piece incentives), Freight Rate Shipment (e.g., indicates whether the shipment is billed as freight or not), Data Source Code (indicates whether a transaction are based on customer's key entry data or pertains to an additional charge applied based on additional information gathered by the carrier, for example, based on scanner information), Scan Based Billing Shipment (e.g., indicates whether shipment opted to scanned based billing rather than default billing based on shipper's key entry PLD), Return Shipment (e.g., indicates if shipment is a forward moving or return shipment), Minimum Charge Applied Indicator (e.g., indicates if the shipment has been charged at the minimum rate allowed), and/or Bill Term (indicates whether the shipper of consignee is the payer of the shipment billing charges). Each category may be associated with a plurality of category attributes. For example, the Freight Rate Shipment category may be associated with the category attributes (a) Yes, indicating a transaction associated with this category attribute is a freight rate shipment, or (b) No, indicating a transaction associated with this category attribute is not a freight rate shipment. In another example, the Zone Number category may be associated with the category attributes 001, 002, 003, 004, 005, or 006. For example, a transaction associated with the category attribute 003 may indicate that the item and/or shipment associated with the transaction was transported to the geographical region denoted as zone 003.

As should be understood, a variety of categories may be defined as appropriate for the application. In various embodiments, the selection of the categories may be configured to balance Type I errors (e.g., alpha errors; wherein a true null hypothesis is incorrectly rejected) and Type II errors (e.g., beta errors; wherein a false null hypothesis fails to be rejected) and to increase the statistical power of the comparison of the current profile to the historical profile. For instance, alpha (e.g., the probability that a true null hypothesis will be incorrectly rejected) and beta (the probability that a false null hypothesis will fail to be rejected) are balanced while increasing the statistical power (1-beta). In some embodiments, the selection of the categories may be configured to ensure a sufficient and/or optimal distribution of transactions to provide a meaningful statistical inference and post analysis of the comparison of the current profile to the historical profile. In various embodiments, the user (e.g., via display/input device 104 or a computing device in communication with the billing system 100) may select to perform the analysis of the historical data sets based on all of the categories, one of the categories, or a subset of the categories via the category selector 712.

In various embodiments, the user (e.g., via display/input device 104 or a computing device in communication with the billing system 100) may select one or more variables to analyze to validate the application of incentives to a customer account and/or identify anomalies therein via the variable selector 714. In one embodiment, the variables may comprise the item billed weight, item quantity, item dimensions, item volume, gross amount, net amount, and/or the like. The user may select one or more variables to be used as the basis for the statistical representations of the historical billing information/data and current billing information/data used to characterize and/or calculate/generate/determine the historical and current profiles via the variable selector 714.

After providing the requested information, the user (e.g., via display/input device 104 or a computing device in communication with the billing system 100) may select the submit button 716 (or use any of a variety of other input options) to submit the analysis request. After receiving the analysis request, or possibly in response thereto, the billing system 100 may initiate, schedule, and/or the like the analysis or analyses of the current billing information/data as indicated by the analysis request. As should be understood an analysis request may include various information and/or data pertaining to validating the application of incentives to the customer account and/or identifying anomalies therein. As noted above, in some embodiments, the billing system 100 or other appropriate computing entity may automatically submit one or more analysis requests based on predetermined and/or default parameters.

### 2. Generation of the Historical Profile

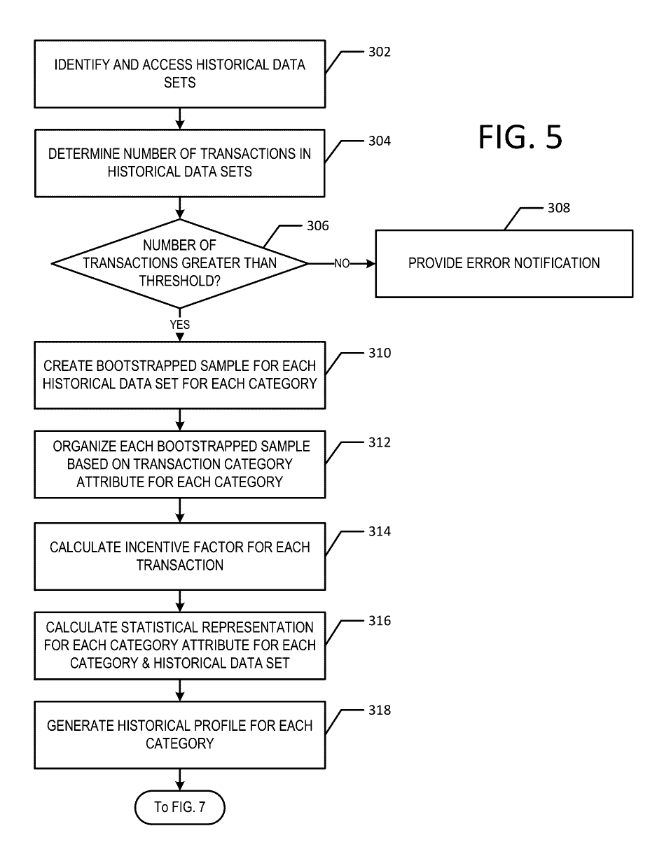

FIG. 5 provides a flowchart illustrating processes and procedures that may be completed as part of generating a historical profile for validating the application of incentives to a customer account and/or identifying anomalies therein, in accordance with various embodiments. Starting at step 302, the analysis begins by identifying and accessing the historical billing information/data indicated by the analysis request. For example, the billing system 100 (e.g., the processor 110) may identify and access the historical billing information/data (e.g., from the billing database 140) indicated by the analysis request. For example, for customer XYZ Corp. having a weekly billing cycle, the analysis request may indicate that 6 billing cycles (e.g., 6 weeks) of historical billing information/data should be analyzed to create a historical profile and the historical billing information/data should be analyzed as six data sets with each data set corresponding to a billing cycle (e.g., one week) of historical billing information/data. Thus, the historical billing information/data for the six billing cycles (e.g., six weeks) immediately preceding the current billing cycle (e.g., the billing cycle currently being processed for billing) for XYZ Corp. may be identified and accessed to generate, calculate, determine, populate, create, build, and/or similar words used herein interchangeably six historical data sets by the billing system 100.

At step 304, the number of transactions in each historical data set and/or the total number of transactions in all of the historical data sets may be determined. For example, the billing system 100 may determine that XYZ Corp. had 50 transactions for the historical data set corresponding to Mar. 20, 2015-Mar. 26, 2015, 52 transactions for the historical data set corresponding to Mar. 27, 2015-Apr. 2, 2015, 86 transactions for the historical data set corresponding to Apr. 3, 2015-Apr. 9, 2015, 32 transactions for the historical data set corresponding to Apr. 10, 2015-Apr. 16, 2015, 57 transactions for the historical data set corresponding to Apr. 17, 2105-Apr. 23, 2015, and 43 transactions for the historical data set corresponding to Apr. 24, 2015-Apr. 30, 2015. In another example, the billing system 100 may determine that XYZ Corp. had 320 transactions for the historical data sets corresponding to Mar. 20, 2015-Apr. 30, 2015. In various embodiments, each transaction is defined by a category attribute for each category of interest and a variable value for each variable of interest. Each transaction may correspond to one or more services and/or products provided to the customer by the service and/or product provider. For example, the transaction may correspond to the shipping of an item and the transaction may be defined by the attribute next day air corresponding to the category of Service Type, the attribute of pick-up corresponding to the category of Acquisition Method, and the value of 2.5 pounds corresponding to the variable of billed weight for the item.

At step 306, it is determined if the number of transactions in each historical data set and/or the total number of transactions in all of the historical data sets is greater than a configurable threshold value. For example, in one embodiment, a configurable threshold value for the number of transactions in each historical data set may be 40 transactions. In another example, a configurable threshold value for the total number of transactions in all of the historical data sets may be 250 transactions. In some embodiments, only a per data set configurable threshold is utilized. In other embodiments, only a total number configurable threshold is utilized. In yet other embodiments, both a per data set configurable threshold and a total number configurable threshold is utilized. In various embodiments, the per data set and/or total number threshold is predetermined (e.g., stored in association with the customer profile for the client and/or customer or otherwise) and/or provided via the analysis request. Thus, for example, the billing system 100 may determine if the number of transactions in each historical data set and/or the total number of transactions is greater than the per data set and/or total number threshold(s).

If at step 306 it is determined that at least one of the historical data sets has a smaller number of transactions than the per data set threshold and/or that the total number of transactions in all of the historical data sets is less than the total number threshold, the process continues to step 308. At step 308, an error notification is provided and the analysis is ended. For example, the billing system 100 may provide an error notification. For example, the error notification may indicate that the number of transactions present in at least one of the historical data sets and/or the total number of transactions in the historical data sets is too low. For example, the number of transactions present in at least one of the historical data sets and/or the total number of transactions in the historical data sets may be too low to provide a good and/or meaningful statistical representation of the historical billing information/data. For example, the number of transactions present in at least one of the historical data sets and/or the total number of transactions in the historical data sets is too low to provide a statistical representation with sufficient statistical power.

At step 306, if it is determined that all of the historical data sets have a sufficient number of transactions and/or that the total number of transactions is sufficient (e.g., greater than or equal to the per data set and/or total number threshold), the process continues to step 310. At step 310, a bootstrapped sample, or cluster, is calculated/generated/determined for each historical data set. In some embodiments, a bootstrapped sample is calculated/generated/determined for each category for each historical data set. For example, a bootstrapped sample may be calculated/generated/determined for each category such that calculating/generating/determining the portion of the historical profile corresponding to each category may be completed independently and/or in parallel. For example, the billing system 100 may calculate/generate/determine a bootstrapped sample for each historical data set. In various embodiments, the billing system 100 may calculate/generate/determine a plurality of bootstrapped samples for at least one of the historical data sets in order to calculate/generate/determine the average (mean, median, or mode), standard deviation, confidence interval about an average, and/or other statistical representation of the historical data set with higher precision. In various embodiments, random data resampling, Bayesian bootstrap, smooth bootstrap, parametric bootstrap, resampling residuals, Gaussian process regression bootstrap, wild bootstrap, or block bootstrap statistics/methods/algorithms may be used as appropriate. As should be understood, a variety of bootstrapping statistics/methods/algorithms may be utilized as known and understood in the field.

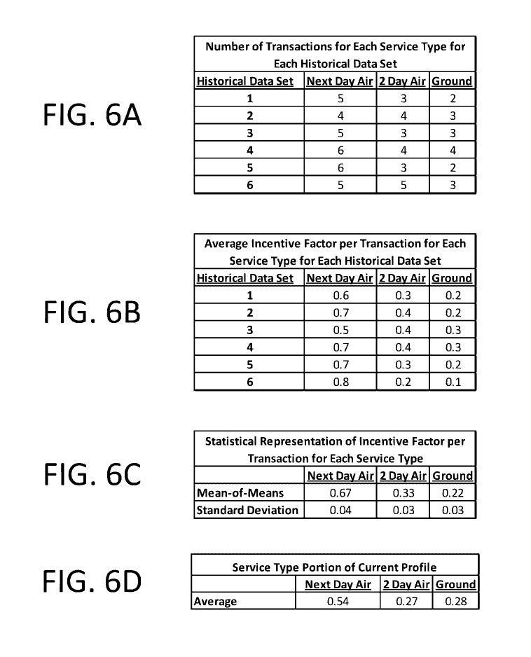

At step 312, each bootstrapped sample is organized for each category based on the category attributes associated with that category. For example, the billing system 100 may organize each bootstrapped sample for each category. For example, as noted above, each transaction is associated with a category attribute for each category. The bootstrapped sample for a particular category may be organized into sub-samples wherein each transaction in a sub-sample is associated with the same category attribute for the particular category. FIG. 6A illustrates an example of organized bootstrapped samples for each historical data set and for the example category “Service Type” having the example category attributes “Next Day Air,” “Second Day Air,” and “Ground.” According to the illustrated example, five transactions in the bootstrapped sample for the first historical data set are associated with the category attribute “Next Day Air.” In some embodiments, the bootstrapped sample may be organized into micro-segments and the historical profile may be calculated/generated/determined based on micro-segments rather than and/or in addition to categories, as described herein. In various embodiments, a micro-segment may be defined by at least one of two or more category attributes associated with different categories, at least one category attribute and at least one variable value or range. For example, a micro-segment may be defined for transactions associated with the category attribute Ground associated with the category Service Type and with category attribute 003 associated with the category Zone Number. Another example micro-segment is defined for transaction associated with the category attribute Pick-up associated with the category Acquisition Method and with the variable range 71-80 pounds associated with the variable Billed Item Weight.

Returning to FIG. 5, at step 314, an incentive factor is calculated for each transaction of the bootstrapped sample. For example, the billing system 100 may calculate an incentive factor for each transaction of the bootstrapped sample, each unique transaction of the bootstrapped sample, and/or the like. The incentive factor for each transaction may be based at least in part on the customer contract, incentives offered to the customer, the category attributes associated with the transaction, the variable values associated with the transaction, and/or the like. In various embodiments, the incentive factor may indicate a fraction of an incentive, a dollar value of the incentive, a fractional discount pertaining to the transaction, and/or the like.

At step 316, a statistical representation of each category is calculated for each historical data set. For example, the billing system 100 may calculate a statistical representation of each category for each historical data set indicated in the analysis request. For example, an average incentive factor (e.g., mean, median, or mode) and standard deviation may be calculated for each category attribute for each historical data set. FIG. 6B illustrates an example statistical representation of the samples shown in FIG. 6A. For example, the mean incentive factor for the five transactions in the bootstrapped sample for the first historical data set and associated with the category attribute “Next Day Air” may be 0.6. As should be understood, a variety of statistical models may be used to calculate the statistical representation of each category for historical data set. In various embodiments, the statistical representation of each category may be determined based on the analysis type associated with the analysis request. In some embodiments, the statistical representation of each category may be determined based on a preferred analysis type for the category and/or based on information/data stored in association with a customer profile for the customer associated with the billing information/data.

Returning to FIG. 5, at step 318, the historical profile for the customer may be calculated/generated/determined. For example, the billing system 100 may generate the historical profile for the customer based on the statistical representations for the category for each historical data set. For instance, generating the historical profile may comprise calculating/generating/determining one or more statistical models of the historical billing information/data based on the statistical representations calculated at step 316. For example, an average (e.g., mean, median, or mode) may be calculated based on the statistical representations for the category. For instance, generating the historical profile may comprise calculating/generating/determining an average incentive factor and corresponding standard deviation via a mean-of-means calculation for each attribute associated with a category. For example, FIG. 6C provides a historical profile for the example category “Service Type.” The historical profile shown in FIG. 6C comprises a mean-of-means for the incentive factor for each category attribute, wherein the mean-of-means is the mean of the mean calculated for each historical data set, as shown in FIG. 6B. The example illustrated historical profile also comprises the standard deviation. In various embodiments, the standard deviation associated with the mean-of-means may be a pool variance, weighted standard deviation, standard error, and/or the like. Thus, in various embodiments, a historical profile for the customer may comprise a set of mean-of-means and corresponding standard deviations (or other statistical model) for at least one of the categories indicated in the analysis request. For example, the set of mean-of-means and corresponding standard deviation (or other statistical model) may comprise a mean-of-means and corresponding standard deviation for each category attribute for at least one category. In various embodiments, an independent historical profile may be calculated/generated/determined for each category indicated in the analysis request, for example, to facilitate parallel processing of the validation analysis.

### 3. Generation of the Current Profile

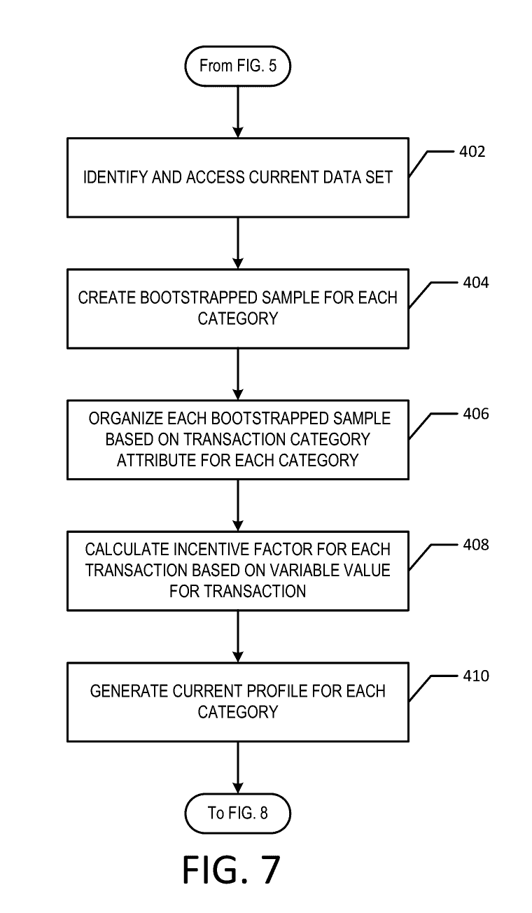

FIG. 7 provides a flowchart illustrating processes and procedures that may be completed to calculate/generate/determine a current profile for a customer, in accordance with various embodiments of the present invention. At step 402 the current billing information/data is identified and accessed. For example, the billing information/data for the current billing cycle (e.g., the billing cycle currently being processed for billing) for the customer indicated in the analysis request may be identified and accessed. For example, the billing system 100 may identify and access (e.g., via the processor 110) the current billing information/data (e.g., stored in the billing database 140) for the customer. In various embodiments, the current billing information/data may comprise billing information/data for the current billing cycle (e.g., the billing cycle that is currently being processed for billing).

At step 404, a bootstrapped sample is calculated/generated/determined for each historical data set. In some embodiments, a bootstrapped sample is calculated/generated/determined for each category indicated by the analysis request. For example, a bootstrapped sample may be calculated/generated/determined for each category such that calculating/generating/determining the portion of the current profile corresponding to each category may be completed independently and/or in parallel. For example, the billing system 100 may calculate/generate/determine a bootstrapped sample for the current data set. As should be understood, a variety of bootstrapping statistics/methods/algorithms may be utilized as known and understood in the field.

At step 406, each bootstrapped sample is organized for each category based on the category attributes associated with that category. For example, the billing system 100 may organize each bootstrapped sample for each category. For instance, as noted above, each transaction is associated with a category attribute for each category. The bootstrapped sample for a particular category may be organized into sub-samples wherein each transaction in a sub-sample is associated with the same category attribute for the particular category.

At step 406, an incentive factor is calculated for each transaction of the bootstrapped sample. For example, the billing system 100 may calculate an incentive factor for each transaction of the bootstrapped sample, each unique transaction of the bootstrapped sample, and/or the like. The incentive factor for each transaction may be based at least in part on the customer contract, incentives offered to the customer, the category attributes associated with the transaction, the variable values associated with the transaction, and/or the like. In various embodiments, the incentive factor may indicate a fraction of an incentive, a dollar value of incentive, a fractional discount pertaining to the transaction, and/or the like.

At step 408, a current profile is calculated/generated/determined for the customer. For example, the billing system 100 may calculate/generate/determine a current profile for the customer. For instance, a statistical representation of each category may be calculated. For example, an average (e.g., mean, median, or mode) and/or standard deviation may be calculated for category attribute. As should be understood, a variety of statistical models may be used to calculate the statistical representation of each category. In various embodiments, the statistical representation for a particular category attribute may be the average (e.g., mean, median, or mode) incentive factor for transactions of the bootstrapped sample and/or current data set associated with the particular category attribute. FIG. 6D illustrates an example current profile for the customer for the example category “Service Type.” Thus, in various embodiments, the current profile for the customer may comprise, for each category indicated in the analysis request, a set of averages (or other statistical representation) wherein each average corresponds to a particular category attribute for the category. For example, in various embodiments, the statistical representation of each category may be determined based on the analysis type associated with the analysis request. In some embodiments, the statistical representation of each category may be determined based on a preferred analysis type for the category and/or based on information/data stored in association with a customer profile for the customer associated with the billing information/data. In various embodiments, an independent current profile may be calculated for each category indicated in the analysis request, for example, to facilitate parallel processing of the validation analysis.

4. Validation and/or Identification of Anomalies

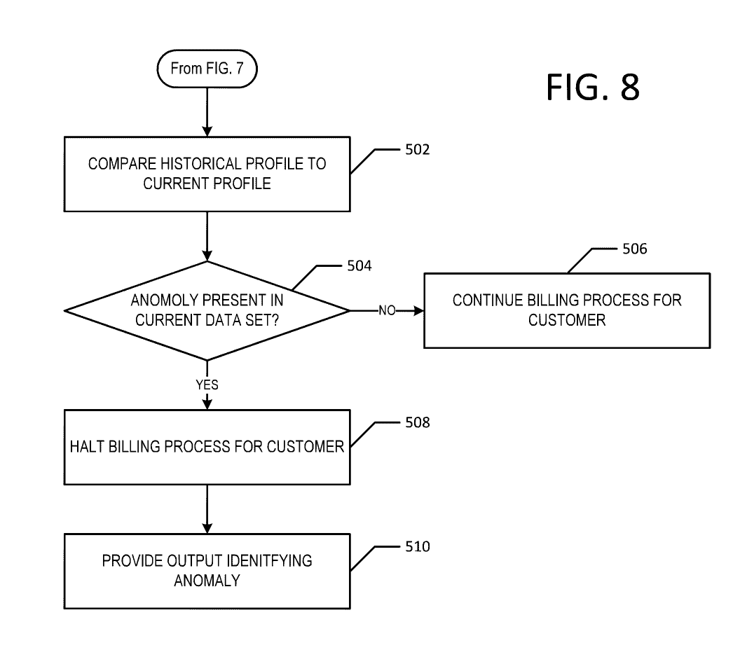

FIG. 8 provides a flowchart illustrating processes and procedures that may be completed in the validation of the application of incentives to a customer account and/or the identification of anomalies therein. At step 502, the current profile is compared to the historical profile using one or more statistical tests. For example, for each category attribute, a z-test may be used to compare the mean incentive factor of the current profile for the category attribute to the mean-of-means of the incentive factor from the historical profile for the category attribute. For example, comparing the example historical profile shown in FIG. 6C and current profile shown in FIG. 6D using a z-test provides a z-score of −3.25 for the category attribute “Next Day Air,” a z-score of −2.0 for the category attribute “Second Day Air”, and a z-score of 2.0 for the category attribute “Ground.” In various embodiments, a z-test, chi-squared test, or KS test may be used to compare the current profile to the historical profile. As noted above, the statistical test used may be identified by the statistical analysis indicated in the analysis request and/or the statistical test associated with the particular category or variable being considered.

In various embodiments, a configurable threshold test statistic may be defined in the request, as data/information stored in association with the customer profile, as an analysis default value, and/or the like. The test statistic may be compared to and/or analyzed based on the threshold test statistic. In some embodiments, the threshold test statistic may depend on the category or category attribute. In one embodiment, for at least one category or category attribute, the threshold test statistic is a z-score of 3.5. If one or more of the test statistics are greater than the corresponding threshold test statistic, than an anomaly may be present in the application of incentives to the customer account in the current billing information/data. For example, if the threshold statistic value is a z-score of 3.5, then a test score of z-score greater than or equal to 3.5 or less than or equal to −3.5 indicates the presence of one or more anomalies in the application of incentives to the customer account in the current billing information/data. In various embodiments, the configurable threshold test statistic may be a chi-squared value, a p-value, a KS statistic, a z-score, a t-score, and/or the like, as appropriate for the analysis.

At step 504, it is determined if one or more anomalies are present in the current billing information/data if one or more of the test statistics are greater than the corresponding threshold test statistic. In some embodiments, it may be determined that one or more anomalies are present in the current billing information/data if one or more of the test statistics are less than or equal to corresponding threshold test statistic, based on the type of statistical test employed (e.g., chi-squared test, KS test, z-test, and/or the like). For example, the billing system 100 may determine if one or more anomalies are present in the current billing information/data. For example, it may be determined if any of the test statistics, when compared to the corresponding threshold statistic value, indicate an anomaly in the application of incentives to a customer account in the current billing information/data. Continuing with the example provided above, the comparison of the current profile to the historical profile for the Service Type category provided z-scores of −3.25, −2.0, and 2.0. Therefore, with a threshold z-score of 3.5, the application of incentives to the customer account in the current billing information/data is validated and no anomalies are identified. If the threshold test statistic is a chi-squared statistic, chi-squared statistics comparing the current profile to the historical profile would be generated/calculated/determined, and the resulting chi-squared statistics would be compared against the threshold chi-squared statistic. Various other statistical tests and their corresponding test statistics may be used (e.g., KS test and KS statistic) as appropriate.

If at step 504, it is determined that no anomalies are present in the current billing information/data, the process continues to step 506. At step 506, the billing process for the customer continues. For example, the customer may be invoiced for the transactions corresponding to the current billing information/data.

If at step 504, it is determined that one or more anomalies are present in the current billing information/data, the process continues to step 508. At step 508, the billing process for the customer is paused or halted. For example, the customer may not be invoiced until after the identified anomaly is investigated. For example, the billing system 100 may pause and/or halt the billing process for the customer so the detected anomaly may be investigated before the customer is billed and/or invoiced for the transactions corresponding to the current billing information/data. To do so, the billing system 100 can flag the current billing information/data, calculate/generate/determine an alert, and/or the like.

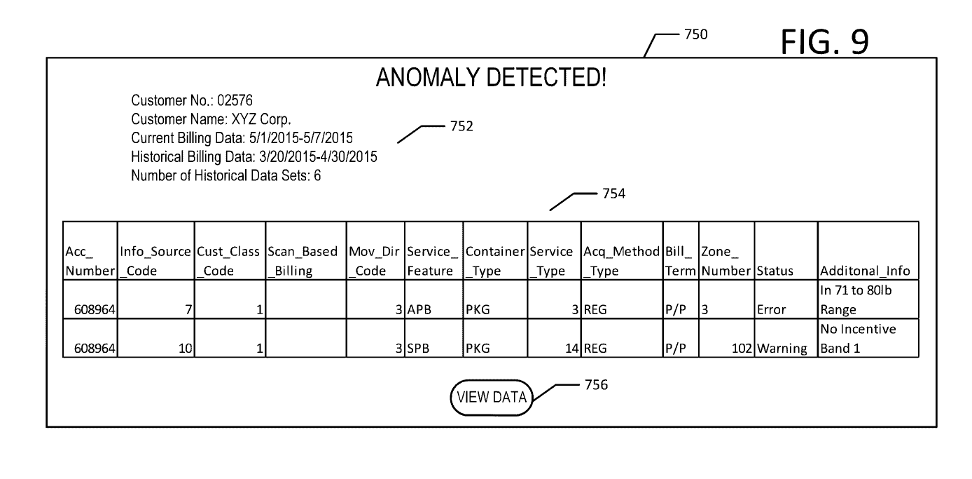

At step 510, output providing information corresponding to the identified anomaly is provided. For example, the billing system 100 may provide information corresponding to the identified anomaly via a detected anomaly interface 750 (as shown in FIG. 9), via a text message, email, and/or the like associated with a user (e.g., an employee of the service and/or product provider). In one embodiment, the output is provided as a spreadsheet (e.g., an Excel spreadsheet) with information/data corresponding to each detected anomaly provided as a row in the spreadsheet. In various embodiments, the provided information may indicate that an anomaly has been identified and/or identify at least one of the customer for which the anomaly has been detected, the category or micro-segment for which the anomaly has been detected, the test statistic associated with the detected anomaly, a portion of the micro-segment distribution associated with the detected anomaly, or a particular data point of the current billing information/data associated with the detected anomaly. In various embodiments, the output may provide the information necessary for a user to investigate the detected anomaly to determine if the anomaly is an error in the current billing information/data or if the customer's service and/or product consumption has changed since the previous billing cycle.

FIG. 9 provides an example detected anomaly interface 750. The example interface 750 comprises analysis information 752, anomaly information 754, and a view data button 756. The analysis information 752 may be configured to provide information regarding the customer associated with the anomaly, one or more parameters associated with the analysis, information identifying the current billing information/data, and/or the like. The anomaly information 754 provides information corresponding to the detected anomaly. Each row of the anomaly information 754 (other than any header row(s)) may indicate a detected anomaly. The anomaly information 754 may identify a category, category attribute, and/or particular data point associated with the detected anomaly. The anomaly information 754 may also indicate what type of anomaly was detected. For example, the first row of the anomaly information 754 shows the identification of anomaly in the micro-segment defined by category attributes Account Number 608964, Info Source Code 7, Customer Class Code 1, False Scan Based Billing, Movement Direction Code 3, Service Feature APB, Container Package, Service Type 3, Acquisition Method Type REG, Bill Term P/P, and Zone Number 3. The anomaly information 754 also indicates that the error is associated with the transactions corresponding to items and/or shipments in the 71-80 pound range. The second row of the anomaly information 754 shows that a warning was issued for a particular micro-segment there was no incentive applied for a Band 1. The view data button 756 may be configured to provide a user (e.g., via display/input device 104 or a computing device in communication with the billing system 100) with the current billing information/data associated with the detected anomaly. For example, if the user selects view data button 756, a table may be displayed (e.g., via the display/input device 104 or a computing device in communication with the billing system 100 and/or billing database 140) providing at least a portion of the current billing information/data corresponding to the detected billing anomaly.

In various embodiments, the user may investigate any detected anomalies to determine if the anomaly is an error in the current billing information/data or if the customer's service and/or product consumption has changed since the previous billing cycle. If the customer's service and/or product consumption for transactions corresponding to the current billing information/data is different from the historical billing information/data, the billing process may be resumed. For example, the user (e.g., via display/input device 104 or a computing device in communication with the billing system 100) may provide input via an anomaly resolution interface indicating that the anomaly is not an error in the billing information/data and the billing process should be resumed. If the detected anomaly does indicate an error in the current billing information/data, the user (e.g., via display/input device 104 or a computing device in communication with the billing system 100) may modify, edit, and/or correct the current billing information/data to correct the error, and/or otherwise correct the error before the billing process for the customer is resumed. For example, the user may provide input via an anomaly resolution interface to modify, edit, and/or correct the current billing information/data and/or to resume the billing process for the customer.

### V. CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for identifying an anomaly in billing data, the method comprising:
receiving historical billing data for a customer, the historical billing data corresponding to one or more billing cycles preceding a current billing cycle, the current billing cycle being a billing cycle for which the customer has not yet been billed, the historical billing data organized into a plurality of historical data sets with each historical data set comprising a plurality of historical transactions, each historical transaction being associated with one or more category attributes, each of the one or more category attributes associated with a unique category;
calculating a plurality of statistical representations of each of the plurality of historical data sets, wherein each of the plurality statistical representations is associated with at least one category attribute;
generating a historical profile for the customer, the historical profile associated with at least one category attribute and based at least in part on the statistical representations corresponding to the at least one category attribute, the historical profile being a statistical model of the historical billing data;
receiving current billing data for the customer, the current billing data corresponding to the current billing cycle for the customer, the current billing data comprising a plurality of current transactions, each current transaction associated with one or more current category attributes, each of the one or more current category attributes associated with a unique category;
generating a current profile for the customer, the current profile associated with at least one category attribute, the current profile being a statistical model of the current billing data;
comparing the current profile to the historical profile, the current profile and the historical profile being associated with the same at least one category attribute; and
based at least in part on the result of the comparison, determining whether one or more anomalies are present in the current billing data for the customer.

2. The method of claim 1 wherein comparing the current billing data to the historical profile comprises computing one or more test statistics.

3. The method of claim 2 wherein the one or more test statistics is selected from the group consisting of a z-score, a chi-squared statistic, or a Kolmogorov-Smirnov statistic.

4. The method of claim 2 wherein determining if one or more anomalies are present in the current billing data comprises comparing the one or more test statistics to a corresponding threshold test statistic.

5. The method of claim 1 further comprising generating a bootstrapped sample for each historical data set, and wherein the plurality of statistical representations for each historical data set are calculated based at least in part on the bootstrapped sample for the corresponding historical data set.

6. The method of claim 1 wherein calculating each statistical representation comprises calculating at least one of a mean, median, mode, or standard deviation; and
wherein generating each historical profile comprises calculating at least one of a mean-of-means, median, mode, or standard error based on the corresponding statistical representations.

7. The method of claim 1 further comprising:
calculating a plurality of statistical representations for a micro-segment, each statistical representation associated with one of the plurality of historical data sets, wherein each micro-segment is associated with at least one of two or more category attributes or at least one category attribute and at least one variable range;
generating a historical profile for the micro-segment based at least in part on the statistical representations for the micro-segment;
generating a current profile based at least in part on statistical representation for a micro-segment; and
comparing the historical profile for the micro-segment and the current profile for the micro-segment.

8. The method of claim 1 wherein each of the historical data sets comprises historical billing data for one billing cycle.

9. The method of claim 1 wherein each statistical representation corresponds to an average incentive factor.

10. A system for identifying anomalies in billing data, the system comprising at least one processor and at least one memory, the at least one memory, with the processor, cause the system to at least:
receive historical billing data for a customer, the historical billing data corresponding to one or more billing cycles preceding a current billing cycle, the current billing cycle being a billing cycle for which the customer has not yet been billed, the historical billing data organized into a plurality of historical data sets with each historical data set comprising a plurality of historical transactions, each historical transaction being associated with one or more category attributes, each of the one or more category attributes associated with a unique category;
calculate a plurality of statistical representations of each of the plurality of historical data sets, wherein each of the plurality statistical representations is associated with at least one category attribute;
generate a historical profile for the customer, the historical profile associated with at least one category attribute and based at least in part on the statistical representations corresponding to the at least one category attribute, the historical profile being a statistical model of the historical billing data;
receive current billing data for the customer, the current billing data corresponding to the current billing cycle for the customer, the current billing data comprising a plurality of current transactions, each current transaction associated with one or more current category attributes, each of the one or more current category attributes associated with a unique category;
generate a current profile for the customer, the current profile associated with at least one category attribute, the current profile being a statistical model of the current billing data;
compare the current profile to the historical profile, the current profile and the historical profile being associated with the same at least one category attribute; and
based at least in part on the result of the comparison, determine whether one or more anomalies are present in the current billing data for the customer.

11. The system of claim 10 wherein comparing the current billing data to the historical profile comprises computing one or more test statistics.

12. The system of claim 11 wherein the one or more test statistics is selected from the group consisting of a z-score, a chi-squared statistic, or a Kolmogorov-Smirnov statistic.

13. The system of claim 11 wherein determining if one or more anomalies are present in the current billing data comprises comparing the one or more test statistics to a corresponding threshold test statistic.

14. The method of claim 10 further comprising generating a bootstrapped sample for each historical data set, and wherein the plurality of statistical representations for each historical data set are calculated based at least in part on the bootstrapped sample for the corresponding historical data set.

15. The method of claim 10 wherein calculating each statistical representation comprises calculating at least one of a mean, median, mode, or standard deviation; and
wherein generating each historical profile comprises calculating at least one of a mean-of-means, median, mode, or standard error based on the corresponding statistical representations.

16. The method of claim 10 further comprising:
calculating a plurality of statistical representations for a micro-segment, each statistical representation associated with one of the plurality of historical data sets, wherein each micro-segment is associated with at least one of two or more category attributes or at least one category attribute and at least one variable range;
generating a historical profile for the micro-segment based at least in part on the statistical representations for the micro-segment;
generating a current profile based at least in part on statistical representation for a micro-segment; and
comparing the historical profile for the micro-segment and the current profile for the micro-segment.

17. The method of claim 10 wherein each of the historical data sets comprises historical billing data for one billing cycle.

18. The method of claim 10 wherein each statistical representation corresponds to an average incentive factor.

19. A non-transitory computer program product comprising at least one computer-readable storage medium having computer-readable program code portions embodied therein, the computer-readable portions comprising:
an executable portion configured to receive historical billing data for a customer, the historical billing data corresponding to one or more billing cycles preceding a current billing cycle, the current billing cycle being a billing cycle for which the customer has not yet been billed, the historical billing data organized into a plurality of historical data sets with each historical data set comprising a plurality of historical transactions, each historical transaction being associated with one or more category attributes, each of the one or more category attributes associated with a unique category;
an executable portion configured to calculate a plurality of statistical representations of each of the plurality of historical data sets, wherein each of the plurality statistical representations is associated with at least one category attribute;
an executable portion configured to generate a historical profile for the customer, the historical profile associated with at least one category attribute and based at least in part on the statistical representations corresponding to the at least one category attribute, the historical profile being a statistical model of the historical billing data;
an executable portion configured to receive current billing data for the customer, the current billing data corresponding to the current billing cycle for the customer, the current billing data comprising a plurality of current transactions, each current transaction associated with one or more current category attributes, each of the one or more current category attributes associated with a unique category;
an executable portion configured to generate a current profile for the customer, the current profile associated with at least one category attribute, the current profile being a statistical model of the current billing data;
an executable portion configured to compare the current profile to the historical profile, the current profile and the historical profile being associated with the same at least one category attribute; and
an executable portion configured to, based at least in part on the result of the comparison, determine whether one or more anomalies are present in the current billing data for the customer.

20. The computer program product of claim 19 wherein comparing the current billing data to the historical profile comprises computing one or more test statistics.
